(19) United States
(12) Patent Application Publication
(10) Pub. No.: US 2022/0240140 A1
(43) Pub. Date: Jul. 28, 2022

(54) USER EQUIPMENT, BASE STATION AND METHOD OF PERFORMING CONDITIONAL HANDOVER

(71) Applicant: LENOVO (BEIJING) LIMITED, Beijing (CN)

(72) Inventors: Lianhai Wu, Beijing (CN); Joachim Lohr, Wiesbaden (DE); Prateek Basu Mallick, Dreieich (DE); Jie Shi, Beijing (CN); Haiming Wang, Beijing (CN); Jing Han, Beijing (CN)

(21) Appl. No.: 17/606,613

(22) PCT Filed: Apr. 26, 2019
(86) PCT No.: PCT/CN2019/084631

§ 371 Date: Oct. 26, 2021

(51) Int. Cl. H04W 36/00; H04W 36/08; H04W 36/30

(52) U.S. Cl. CPC H04W 36/00837; H04W 36/30; H04W 36/08

(57) ABSTRACT

The present application relates to a user equipment, a base station and a method of performing conditional handover. The base station transmits a conditional handover message to the user equipment. The conditional handover message includes a trigger condition and a timer corresponding to a target cell. The user equipment receives the conditional handover message from the base station for performing conditional handover when needed. The user equipment determines that the trigger condition is met and then starts the first timer for controlling period of performing conditional handover to the target cell.

### TECHNICAL FIELD

The present disclosure generally relates to user equipment, base station and method of performing handover, and more particularly to user equipment, base station and a method of performing conditional handover.

### BACKGROUND OF THE INVENTION

In a Long Term Evolution (LTE) system, some handover failures occur when a User Equipment (UE) performs conventional handover from a source base station to a target station. In order to avoid these handover failures, conditional handover is introduced. However, in conditional handover, handover failure could still happen but there is no scheme for handling handover failure for conditional handover.

### BRIEF SUMMARY OF THE INVENTION

One embodiment of the present disclosure provides a method performed by a user equipment. The method includes: receiving, by a user equipment, a conditional handover message from a source base station, wherein the conditional handover message includes a trigger condition and a first timer corresponding to a target cell; determining, by the user equipment, that the trigger condition is met; and starting, by the user equipment, the first timer corresponding to the target cell.

Another embodiment of the present disclosure provides a method performed by a user equipment. The method includes: determining, by a user equipment, that conditional handover to a target cell fails; selecting, by the user equipment, another target cell with a channel quality; determining, by the user equipment, whether to perform conditional handover to the another target cell when the another target cell is associated with a conditional handover message or to perform reestablishment with the another target cell when the another target cell is not associated with the conditional handover message.

Yet another embodiment of the present disclosure provides a method for a base station. The method includes: transmitting, by a base station, a conditional handover message to a user equipment, wherein the conditional handover message includes a trigger condition and a first timer corresponding to a target cell so that the user equipment is capable of determining that the trigger condition is met and starting the first timer corresponding to the target cell.

Yet another embodiment of the present disclosure provides a method for a base station. The method includes: transmitting, by a base station, a conditional handover message with an offset to the user equipment, wherein the offset is used for the user equipment to update a channel quality between the user equipment and a target cell.

Yet another embodiment of the present disclosure provides a user equipment. The user equipment includes a transceiver and a processor. The processor and the transceiver are electrically coupled. The transceiver receives a conditional handover message from a source base station, wherein the conditional handover message includes a trigger condition and a first timer corresponding to a target cell. The processor: determines that the trigger condition is met; and starts the first timer corresponding to the target cell.

Yet another embodiment of the present disclosure provides a user equipment. The user equipment includes a processor for determining that conditional handover to a target cell fails; selecting another target cell with a channel quality; and determining whether to perform conditional handover to the another target cell when the another target cell is associated with a conditional handover message or to perform reestablishment with the another target cell when the another target cell is not associated with the conditional handover message.

Yet another embodiment of the present disclosure provides a base station. The base station includes a transceiver for transmitting a conditional handover message to a user equipment, wherein the conditional handover message includes a trigger condition and a first timer corresponding to a target cell so that the user equipment is capable of determining that the trigger condition is met and starting the first timer corresponding to the target cell.

Yet another embodiment of the present disclosure provides a base station. The base station includes a transceiver for transmitting a conditional handover message with an offset to the user equipment, wherein the offset is used for the user equipment to update a channel quality between the user equipment and a target cell.

### BRIEF DESCRIPTION OF THE DRAWINGS

FIG. 1A is a schematic view of a network system according to an embodiment of the present disclosure.

FIG. 1B is a block diagram of a user equipment according to an embodiment of the present disclosure.

FIG. 1C is a block diagram of a base station according to an embodiment of the present disclosure.

FIG. 2A is a schematic view of a network system according to an embodiment of the present disclosure.

FIG. 2B is a block diagram of a user equipment according to an embodiment of the present disclosure.

FIG. 2C is a block diagram of a base station according to an embodiment of the present disclosure.

FIG. 3A is a schematic view of a network system according to an embodiment of the present disclosure.

FIG. 3B is a block diagram of a user equipment according to an embodiment of the present disclosure.

FIG. 3C is a block diagram of a base station according to an embodiment of the present disclosure.

FIG. 4 is a flowchart diagram according to embodiments of the present disclosure.

FIGS. 5A to 5C are flowchart diagrams according to embodiments of the present disclosure.

FIG. 6 is a flowchart diagram according to an embodiment of the present disclosure.

### DETAILED DESCRIPTION OF THE INVENTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

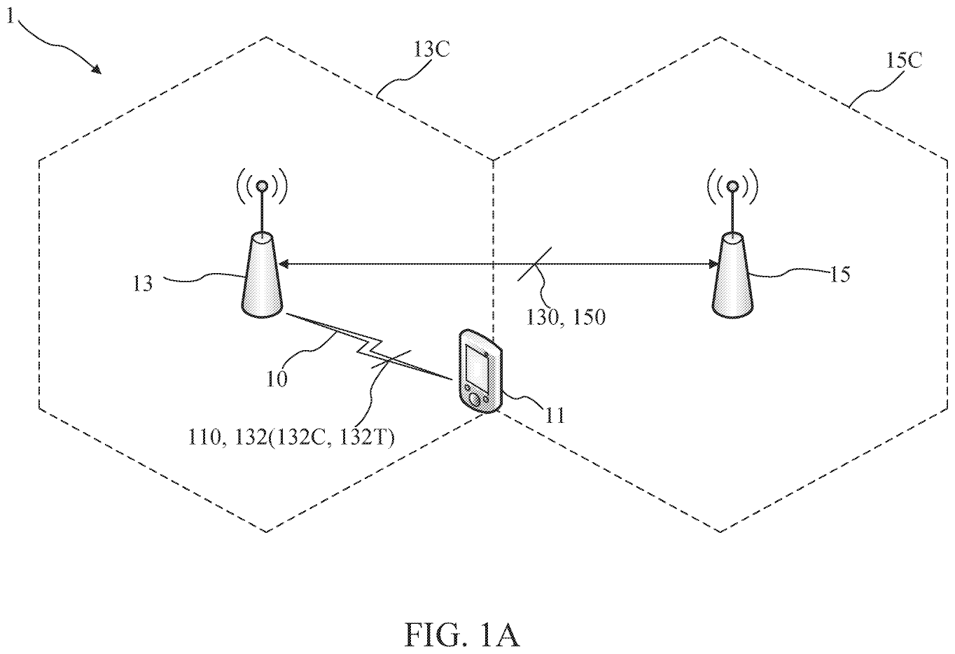

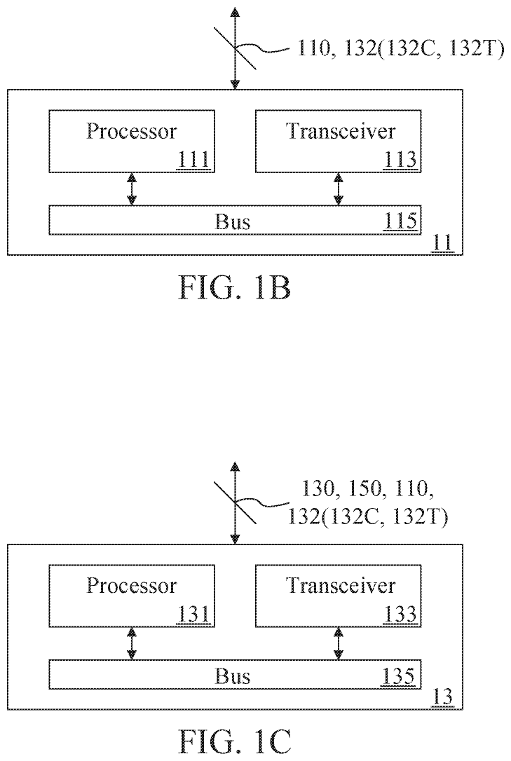

Please refer to FIG. 1A through FIG. 1C. FIG. 1A illustrates a schematic view of a network system 1 according to an embodiment of the present disclosure. FIG. 1B is a block diagram of a user equipment 11 according to the embodiment of the present disclosure. The user equipment 11 includes a processor 111 and a transceiver 113. The processor 111 and the transceiver 113 are coupled through a communication bus 115 allowing the processor 111 to control the transceiver 113 to transmit and/or receive information.

FIG. 1C is a block diagram of a base station 13 according to the embodiment of the present disclosure. Base station 13 includes a processor 131 and a transceiver 133. The processor 131 and the transceiver 133 are coupled through a communication bus 135 allowing the processor 131 to control the transceiver 133 to transmit and/or receive information. The interactions between the individual elements will be further described hereinafter.

In some embodiments, the network system 1 may include the user equipment 11, the base station 13 with a cell 13C and a base station 15 with a cell 15C as shown in FIG. 1A. The user equipment 11 exchanges data with the base station 13 via a network connection 10. At a preparing stage of conditional handover, the transceiver 113 of the user equipment 11 regularly transmits a measurement report 110 to the base station 13 for reporting channel status of the user equipment 11.

After the transceiver 133 of the base station 13 receives the measurement report 110, processor 131 of the base station 13 may identify cell 15C of base station 15 as a target cell for the user equipment 11 to perform conditional handover to when needed. Therefore, the transceiver 133 of the base station 13 transmits a conditional handover request 130 to the base station 15 to notify the base station 15 of a possible conditional handover, and then receives a conditional handover acknowledgement 150 from the base station 15.

Next, the transceiver 133 of the base station 13 transmits a conditional handover message 132 to the user equipment 11 for notifying the user equipment 11 of the cell 15C of the base station 15 as the target cell to perform conditional handover to when needed. The conditional handover message 132 includes a trigger condition 132C and a first timer 132T corresponding to the cell 15C of the base station 15. After the transceiver 113 of the user equipment 11 receives the conditional handover message 132, preparing stage for conditional handover is finished.

Accordingly, when the user equipment 11 is moving away from the base station 13 and toward to the cell 15C of the base station 15, the processor 111 of the user equipment 11 determines whether the trigger condition 132C corresponding to the cell 15C of the base station 15 is met or not. In detail, when the trigger condition 132C corresponding to the cell 15C of the base station 15 is met, it means that the user equipment 11 may perform conditional handover from the base station 13 to the base station 15. Therefore, the processor 111 of the user equipment 11 starts the first timer 132T corresponding to the cell 15C of the base station 15 for controlling the period of performing conditional handover to the cell 15C of the base station 15. In particular, if the first timer 132T expires but the conditional handover has not succeeded yet, the user equipment 11 terminates the conditional handover to the cell 15C of the base station 15.

When the trigger condition 132C corresponding to the cell 15C of the base station 15 is not met, it means that the user equipment 11 may not perform conditional handover from the base station 13 to the cell 15C of the base station 15. Therefore, the processor 111 of the user equipment 11 may keep checking to see if the trigger condition 132C corresponding to the cell 15C of the base station 15 has been met or not.

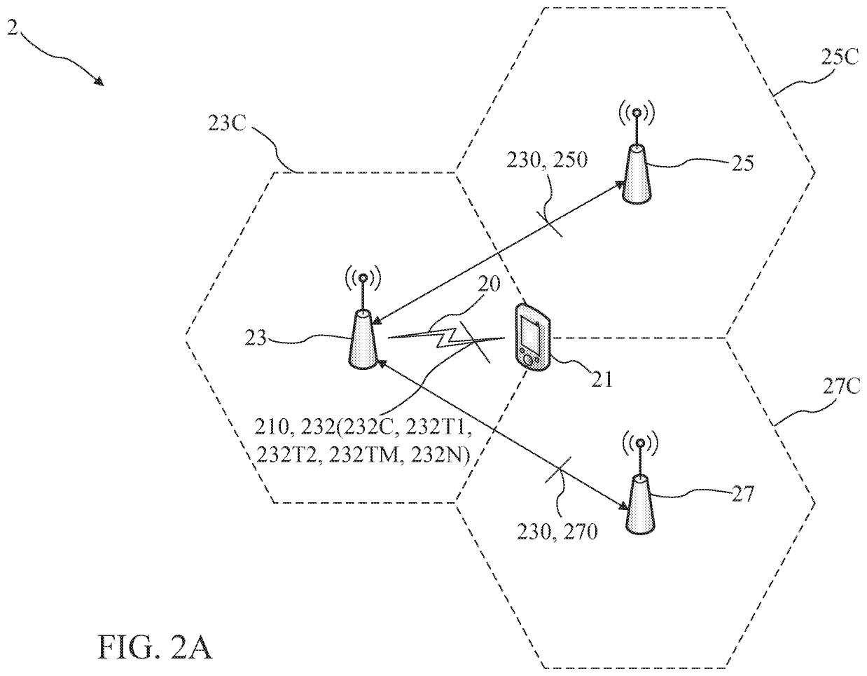

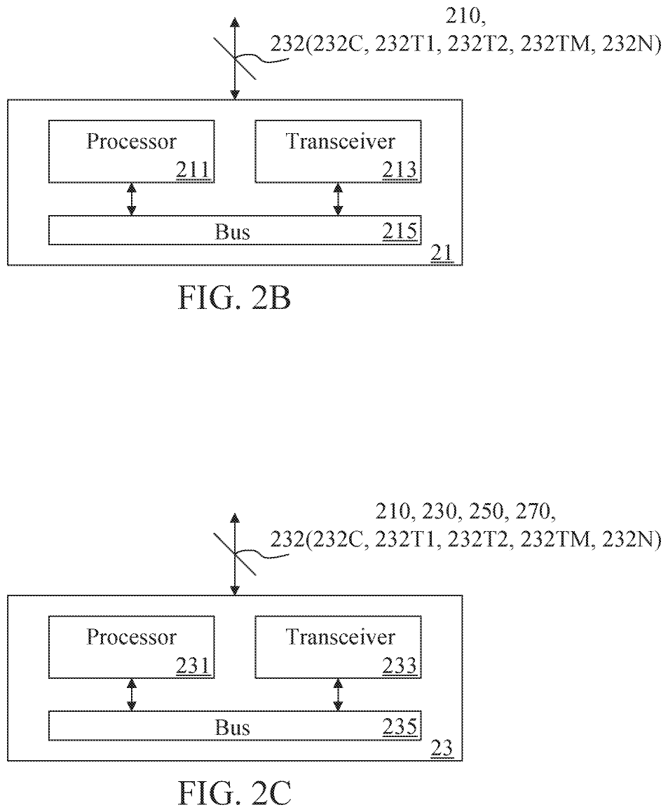

Please refer to FIG. 2A through FIG. 2C. FIG. 2A illustrates a schematic view of a network system 2 according to an embodiment of the present disclosure. FIG. 2B is a block diagram of a user equipment 21 according to the embodiment of the present disclosure. The user equipment 21 includes a processor 211 and a transceiver 213. The processor 211 and the transceiver 213 are coupled through a communication bus 215 allowing the processor 211 to control the transceiver 213 to transmit and/or receive information.

FIG. 2C is a block diagram of a base station 23 according to the embodiment of the present disclosure. Base station 23 includes a processor 231 and a transceiver 233. The processor 231 and the transceiver 233 are coupled through a communication bus 235 allowing the processor 231 to control the transceiver 233 to transmit and/or receive information. The interactions between the individual elements will be further described hereinafter.

In some embodiments, the network system 2 may include a user equipment 21, a base station 23 with a cell 23C, a base station 25 with a cell 25C and a base station 27 with a cell 27C as shown in FIG. 2A. The user equipment 21 exchanges data with the base station 23 via a network connection 20. At a preparing stage of conditional handover, the transceiver 213 of the user equipment 21 regularly transmits a measurement report 210 to the base station 23 for reporting Channel Quality Indicator (CQI) between the user equipment 21 and the base station 23.

After the transceiver 233 of the base station 23 receives the measurement report 210, the processor 231 of the base station 23 may identify cell 25 of the base station 25 and cell 27 of the base station 27 as target cells for the user equipment 21 to perform conditional handover when needed. Therefore, the transceiver 233 of the base station 23 transmits a conditional handover request 230 to the base station 25 for notifying the base station 25 of possible conditional handover, and then receives a conditional handover acknowledgement 250 from the base station 25. Similarly, the transceiver 233 of the base station 23 transmits a conditional handover request 230 to the base station 27 for notifying the base station 27 of possible conditional handover, and then receives a conditional handover acknowledgement 270 from the base station 27.

Next, the transceiver 233 of the base station 23 transmits a conditional handover message 232 to the user equipment 21 for notifying the user equipment 21 of the cell 25C of the base station 25 and of the cell 27C of the base station 27 as the target cells for performing conditional handover when needed. The conditional handover message 232 includes a trigger condition 232C and a first timer 232T1. After the transceiver 213 of the user equipment 21 receives the conditional handover message 232, the preparing stage for conditional handover is finished.

It should be noted that, in some embodiments, the conditional handover message 232 may include a Radio Resource Control Connection Reconfiguration message (e.g., RRCconnectionreconfiguration). The trigger condition 232C of the conditional handover message 232 may be associated with a threshold of channel quality which is used as a benchmark for triggering conditional handover.

In some embodiments, when the user equipment 21 is moving away from the base station 23 and toward cells 25C and 27C of the base stations 25 and 27, respectively, conditional handover may be triggered. Accordingly, processor 211 of the user equipment 21 determines whether a trigger condition 232C is met for cells 25C and 27C of the base stations 25 and 27 respectively.

In detail, as for the cell 25C of the base station 25, the processor 211 of the user equipment 21 measures a first channel quality value (not shown) between the user equipment 21 and the cell 25C of the base station 25 via transceiver 213. Then, the processor 211 of the user equipment 21 determines whether the first channel quality value is greater than the channel quality threshold associated with the trigger condition 232C received as part of the conditional handover message 232.

When the first channel quality value is greater than the channel quality threshold, it means that a channel status between the user equipment 21 and the cell 25C of the base station 25 may be good enough and the user equipment 21 may perform conditional handover from the base station 23 to the cell 25C of the base station 25. Otherwise, when the first channel quality value is not greater than the channel quality threshold, it means that a channel status between the user equipment 21 and the cell 25C of the base station 25 may not be good enough and the user equipment 21 may not perform conditional handover from the base station 23 to the cell 25C of the base station 25.

As for the cell 27C of the base station 27, the processor 211 of the user equipment 21 measures a second channel quality value (not shown) between the user equipment 21 and the cell 27C of the base station 27 via the transceiver 213. Then, the processor 211 of the user equipment 21 determines whether the second channel quality value is greater than the channel quality threshold associated with the trigger condition 232C of the conditional handover message 232.

When the second channel quality value is greater than the channel quality threshold, it means that a channel status between the user equipment 21 and the cell 27C of the base station 27 may be good enough and the user equipment 21 may perform conditional handover from the base station 23 to the cell 27C of the base station 27. Otherwise, when the second channel quality value is not greater than the channel quality threshold, it means that a channel status between the user equipment 21 and the cell 27C of the base station 27 may not be good enough and the user equipment 21 may not perform conditional handover from the base station 23 to the cell 27C of the base station 27.

In some embodiments, the first channel quality value and the second channel quality value are both greater than the channel quality threshold. In other words, cell 25C of the base station 25 and cell 27C of the base station 27 are both candidate target cells for the user equipment 21 to perform conditional handover to.

In some embodiments, the first channel quality value is greater than the second channel quality value. Therefore, the, processor 211 of the user equipment 21 may select cell 25C of base station 25 for performing conditional handover. Then, processor 211 of the user equipment 21 may apply a configuration (not shown) of the conditional handover message 232 for performing conditional handover to the cell 25C of the base station 25. Afterward, the processor 211 of the user equipment 21 may initiate conditional handover to the cell 25C of the base station 25. Then, the processor 211 of the user equipment 21 may initiate Random Access (RA) to the cell 25C of the base station 25.

In some embodiments, the configuration may be the Radio Resource Control Connection Reconfiguration message (e.g., RRCconnectionreconfiguration) which may include a mobility control information (e.g., mobilityControlInfo). The configuration may be applied to the user equipment 21 for the user equipment 21 to set up related network parameters for conditional handover.

As described above, during the conditional handover procedure to cell 25C of the base station 25, there may be at least five operations performed by the user equipment 21, for example: (1) determining that the trigger condition 232C corresponding to the cell 25C of the base station 25 is met (i.e., the first channel quality value is greater than the a channel quality threshold); (2) selecting the cell 25C of the base station 25 for performing conditional handover; (3) applying the configuration of the conditional handover message 232 for performing conditional handover to the cell 25C of the base station 25; (4) initiating conditional handover to the cell 25C of the base station 25; and (5) initiating RA to the cell 25C of the base station 25.

In some embodiments, the processor 211 of the user equipment 21 may start the first timer 232T1 with any one of these operations. In detail, the processor 211 of the user equipment 21 may start the first timer 232T1 when any one of these operations is executed. In other words, the start of the first timer 232T1 and the execution of any one of these operations may occur at the same time. Accordingly, no matter the first timer 232T1 is started with which operation, the user equipment 21 terminates the conditional handover to the cell 25C of the base station 25 once the first time 232T1 expires but the conditional handover has not succeeded yet. Then, the user equipment 21 determines whether the trigger condition 232C is met for another cell.

In some embodiments, the trigger condition 232C is met for cell 27C of the base station 27 (i.e., the second channel quality value is greater than the channel quality threshold). Therefore, the processor 211 of the user equipment 21 selects the cell 27C of the base station 27 for performing conditional handover. Then, the processor 211 of the user equipment 21 may apply a configuration (not shown) of the conditional handover message 232 for performing conditional handover to the cell 27C of the base station 27. Afterward, the processor 211 of the user equipment 21 may initiate conditional handover to the cell 27C of the base station 27. Then, the processor 211 of the user equipment 21 may initiate RA to the cell 27C of the base station 27.

Similarly, during the conditional handover procedure for the cell 27C of the base station 27, there may be at least five operations performed by the user equipment 21, for example: (1) determining that the trigger condition 232C corresponding to the cell 27C of the base station 27 is met (i.e., the second channel quality value is greater than the threshold of channel quality); (2) selecting the cell 27C of the base station 27 for performing conditional handover; (3) applying the configuration of the conditional handover message 232 for performing conditional handover to the cell 27C of the base station 27; (4) initiating conditional handover to the cell 27C of the base station 27; and (5) initiating RA to the cell 27C of the base station 27.

In some embodiments, the processor 211 of the user equipment 21 may reset the first timer 232T1 and start the first timer 232T1 with any one of these operations. In detail, the processor 211 of the user equipment 21 may start the first timer 232T1 when any one of these operations is executed. In other words, the start of the first timer 232T1 and the execution of any one of these operations may occur at the same time. Accordingly, no matter the first timer 232T1 is started with which operation, the user equipment 21 terminates the conditional handover to the cell 27C of the base station 27 when the first time 232T1 expires but the conditional handover has not succeeded yet. Then, the user equipment 21 may determine whether the trigger condition 232C is met for another cell again.

In some embodiments, the first timer 232T1 may be used for controlling the period of performing conditional handover to cell 25C of the base station 25 and for controlling the period of performing conditional handover to cell 27C of the base station 27. In some embodiments, the conditional handover message 232 may further include a second timer 232T2 with the second timer 232T2 being used (as an example) for controlling the period of performing conditional handover to cell 27C of the base station 27.

In some embodiments, the conditional handover message 232 may further include a multi-handover timer 232TM. In detail, the first timer 232T1 (or the second timer 232T2) may be used for controlling the period of performing conditional handover to one cell only, whereas the multi-handover timer 232TM may be used to control the period of performing conditional handover for all available cells.

In some embodiments, the processor 211 of the user equipment 21 starts the multi-handover timer 232TM with the start of the first timer 232T1 associated with the conditional handover to cell 25C of the base station 25. When the first timer 232T1 expires and the processor 211 of the user equipment 21 restarts the first timer 232T1 (or starts the second timer 232T2) for the cell 27C of the base station 27, the multi-handover timer 232TM continues to run for the cell 27C of the base station 27. When the multi-handover timer 232TM expires, the processor 211 of the user equipment 21 stops any possible conditional handover and performs reestablishment with available cell.

In some embodiments, the conditional handover message 232 may further include a maximum number 232N of handover retires, and the maximum number 232N of handover reties may be used for controlling the number of conditional handover attempts with different cells. In detail, once the user equipment 21 terminates conditional handover for one cell, the processor 211 of the user equipment 21 adds one to a counter (with initial value “0”) and checks whether the counter reaches the maximum number 232N. If the counter does not reach the maximum number 232N, the user equipment 21 determines whether the trigger condition 232C is met for another cell. If the counter reaches the maximum number 232N, the processor 211 of the user equipment 21 stops any possible conditional handover attempt and performs reestablishment with available cell.

In some embodiments, processor 211 of the user equipment 21 selects a cell among cells meeting a trigger condition 232C expect for the cell which has been selected for conditional handover.

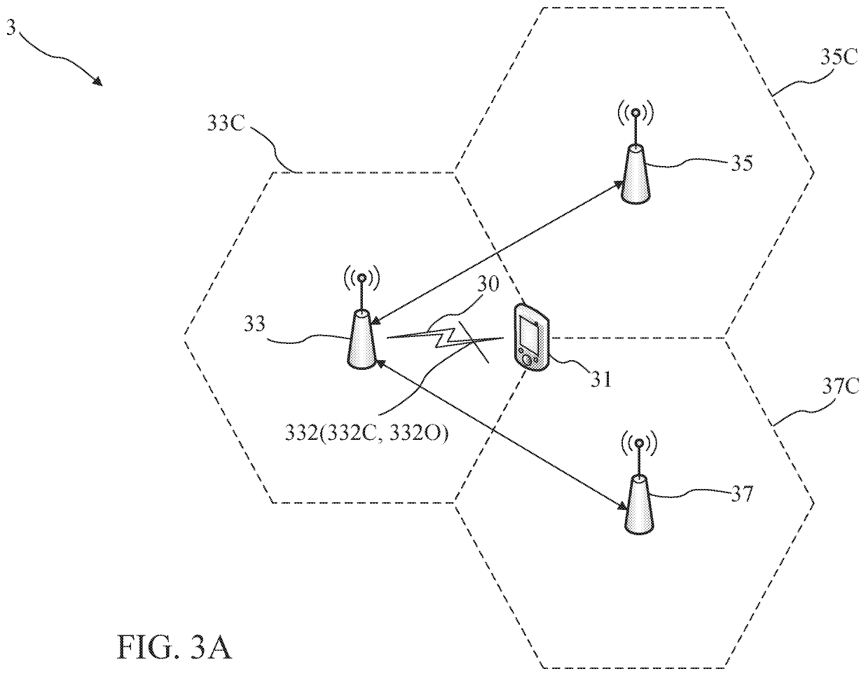

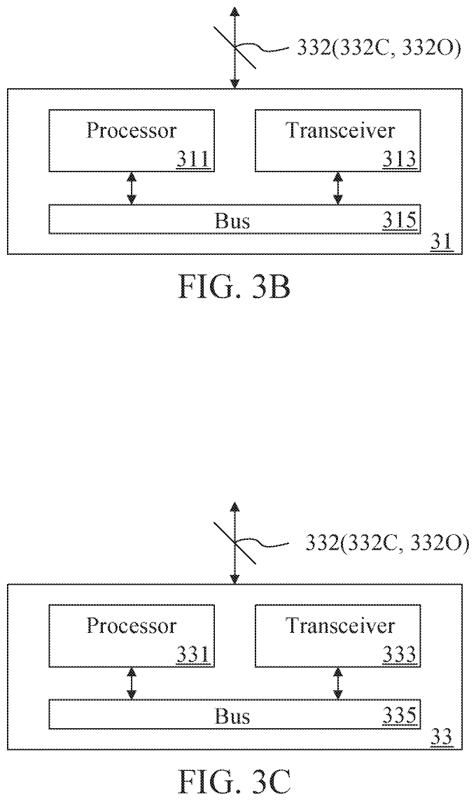

Please refer to FIG. 3A through FIG. 3C. FIG. 3A illustrates a schematic view of a network system 3 according to an embodiment of the present disclosure. FIG. 3B is a block diagram of a user equipment 31 according to the embodiment of the present disclosure. The user equipment 31 includes a processor 311 and a transceiver 313. The processor 311 and the transceiver 313 are coupled through a communication bus 315 allowing the processor 311 to control the transceiver 313 to transmit and/or receive information.

FIG. 3C is a block diagram of a base station 33 according to the embodiment of the present disclosure. Base station 33 includes a processor 331 and a transceiver 333. The processor 331 and the transceiver 333 are coupled through a communication bus 335 allowing the processor 331 to control the transceiver 333 to transmit and/or receive information. The interactions between the individual elements will be further described hereinafter.

In some embodiments, the network system 3 may include the user equipment 31, the base station 33 with a cell 33C, a base station 35 with a cell 35C and a base station 37 with a cell 37C as shown in FIG. 3A. The user equipment 31 exchanges data with the base station 33 via a network connection 30. Before conditional handover, the transceiver 333 of the base station 33 transmits a conditional handover message 332 to the user equipment 31. The conditional handover message 332 includes a trigger condition 332C. Then, the transceiver 313 of the user equipment 31 receives the conditional handover message 332 for performing conditional handover when needed.

In some embodiments, a failure happens when the user equipment 31 is performing conditional handover from base station 33 to the cell 35C of the base station 35. Accordingly, the processor 311 of the user equipment 31 may determine that conditional handover to the cell 35C of the base station 35 fails. Therefore, the processor 311 of the user equipment 31 needs to select another cell.

In particular, when there is no cell meeting the trigger condition 332C for conditional handover, the processor 311 of the user equipment 31 selects a cell with best channel quality for performing conditional handover. In detail, the processor 311 of the user equipment 31 measures a first channel quality value (not show) between the user equipment 31 and the cell 35C of the base station 35, and measures a second channel quality value (not shown) between the user equipment 31 and the cell 37C of the base station 37.

In some embodiments, the second channel quality value is greater than the first channel quality value. Then, the processor 311 of the user equipment 31 ranks the second channel quality value as first priority, and the processor 311 of the user equipment 31 selects the cell 37C of the base station 37 for performing conditional handover or performing reestablishment.

In detail, when cell 37C of the base station 37 is associated with the conditional handover message 332 received from base station 33, it means that the cell 37C of the base station 37 has been selected by the base station 33 for conditional handover and the cell 37C of the base station 37 is prepared for conditional handover. Therefore, the processor 311 of the user equipment 31 may attempt conditional handover with the cell 37C of the base station 37.

Otherwise, when cell 37C of the base station 37 is not associated with the conditional handover message 332 from base station 33, it means that the cell 37C of the base station 37 has not been selected by the base station 33 for conditional handover and the cell 37C of the base station 37 is not prepared for conditional handover. Therefore, the processor 311 of the user equipment 31 performs reestablishment with the cell 37C of the base station 37.

In some embodiments, to improve the chance for cell 37C of the base station 37 to be selected, the conditional handover message 332 may include an offset 332O designated to increase the second channel quality value. In detail, the processor 311 of the user equipment 31 may update the second channel quality value with the offset 332O. In other words, the second channel quality may be added to the offset 332O (i.e., the second channel quality may include the offset). Accordingly, the rank of the cell 37C of the base station 37 for being selected may be raised since second the channel quality value is increased by adding the offset 332O.

In some embodiments, when the cell 37C of the base station 37 is associated with the conditional handover message 332 from the base station 33, it means that the cell 37C of the base station 37 has been selected by the base station 33 for conditional handover and the cell 37C of the base station 37 is prepared for conditional handover. Therefore, the processor 311 of the user equipment 31 determines whether the second channel quality value meets a threshold.

In some embodiments, this threshold may include a cell selection criterion. As Reference Signal Receiving Power (RSRP) for example, the cell selection criterion may include:

Sᵣₓₗₑᵥ=Qᵣₓₗₑᵥₘₑₐₛ−(Qᵣₓₗₑᵥₘᵢₙ₊Q_{rxlevminoffset})−P_{compensation}−Q_{offsettemp}

Where Sᵣₓₗₑᵥ represents cell selection RX level value, Qᵣₓₗₑᵥₘₑₐₛ, represents measured cell receiving level value, Qᵣₓₗₑᵥₘᵢₙ, in represents minimum required receiving level in the cell, Q_{rxlevminoffset} represents Offset to the signaled Qᵣₓₗₑᵥₘᵢₙ taken into account in the Sᵣₓₗₑᵥ evaluation as a result of a periodic search for a higher priority Public Land Mobile Network (PLMN) while camped normally in a Visited-PLMN, P_{compensation} represents power compensation value for the user equipment, and Q_{offsettemp} represents an offset temporarily applied to the cell.

When the processor 311 of the user equipment 31 determines that the second channel quality value meets the cell selection criterion, the processor 311 of the user equipment 31 performs conditional handover with the cell 37C of the base station 37.

It should be noted that the channel quality values and the threshold of the channel quality mentioned above may be related with RSRP or Reference Signal Received Quality (RSRQ).

It shall be particularly appreciated that the processors mentioned in the above embodiments may be a central processing unit (CPU), other hardware circuit elements capable of executing relevant instructions, or combination of computing circuits that are well-known by those skilled in the art based on the above disclosures. Moreover, the transceivers mentioned in the above embodiments may be a combination of a network data transmitter and a network data receiver. Further, the bus may a communication interface for transferring data between CPU and transceiver, and may include electrical bus interface, optical bus interface or even wireless bus interface. However, such description is not intended to limit the hardware implementation embodiments of the present disclosure.

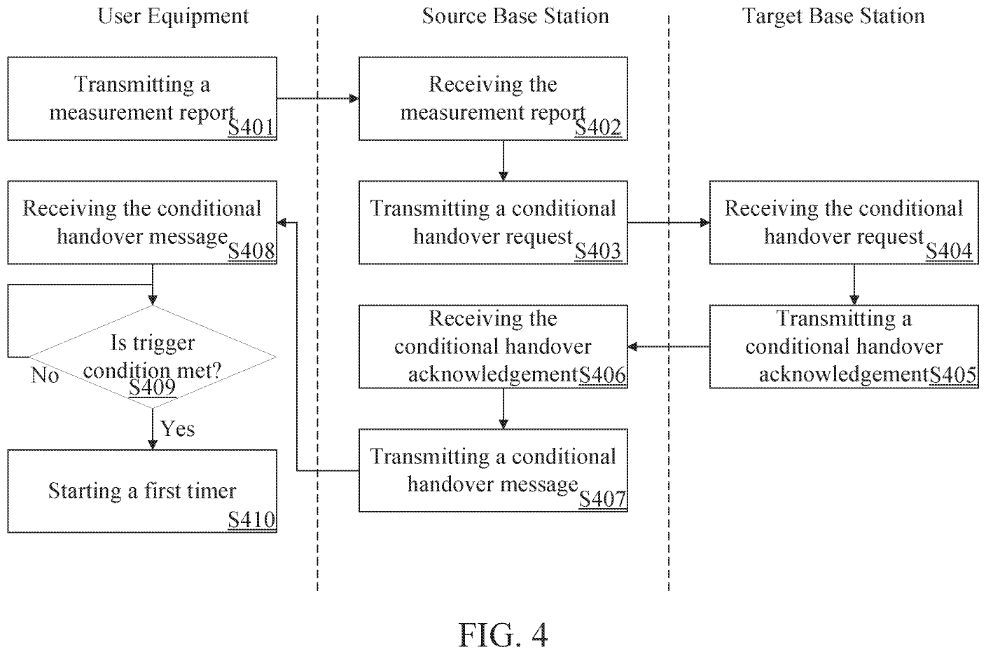

Some embodiments of the present disclosure include a method, and a flowchart diagram thereof is shown in FIG. 4. The method of some embodiments is for use in a network system (e.g., the network system of the aforesaid embodiments), wherein the network system includes a user equipment, a source base station and a target base station with a target cell. Detailed operations of the method are described below.

Operation S401 is executed to transmit, by the user equipment, a measurement report to the source base station. Operation S402 is executed to receive, by the source base station, the measurement report from the user equipment. Then, the source base station may identify the target cell of the target base station for the user equipment to perform conditional handover to when needed. Operation S403 is executed to transmit, by the source base station, a conditional handover request to the target base station for notifying the target base station of a possible conditional handover.

Operation S404 is executed to receive, by the target base station, the conditional handover request from the source base station. Operation S405 is executed to transmit, by the target base station, a conditional handover acknowledge to the source base station. Operation S406 is executed to receive, by the source base station, the conditional handover acknowledge from the target base station.

Operation S407 is executed to transmit, by the source base station, a conditional handover message to the user equipment for notifying the user equipment of the target cell of the target base station for performing conditional handover to when needed. The conditional handover message includes a trigger condition and a first timer corresponding to the target cell of the target base station. Operation S408 is executed to receive, by the user equipment, the conditional handover message.

Operation S409 is executed to determine, by the user equipment, whether the trigger condition is met. If the trigger condition is met for the target cell of the target base station, operation S410 is executed to start, by the user equipment, the first timer for controlling the period of performing conditional handover to the target cell of the target base station. In particular, if the first time expires but the conditional handover has not succeeded yet, the user equipment terminates the conditional handover to the target cell of the target base station. If the trigger condition is not met for the target cell of the target base station, operation S409 is executed by the user equipment to continue checking to see if the trigger condition for the target cell of the target base station is met or not.

In some embodiments, when operation S409 is executed to determine whether the trigger condition is met, there may be at least five sub-operations performed by the user equipment, for example: (1) determining that the trigger condition corresponding to the target cell of the target base station is met; (2) selecting the target cell of the target base station for performing conditional handover; (3) applying a configuration of the conditional handover message for performing conditional handover to the target cell of the target base station; (4) initiating conditional handover to the target cell of the target base station; and (5) initiating RA to the target cell of the target base station.

In some embodiments, operation S410 is executed with any one of these sub-operations. Accordingly, no matter with which sub-operation the first timer is started, the user equipment terminates the conditional handover to the target cell of the target base station when the first time expires but the conditional handover has not successfully terminated yet. Then, the user equipment determines whether the trigger condition is met for another cell.

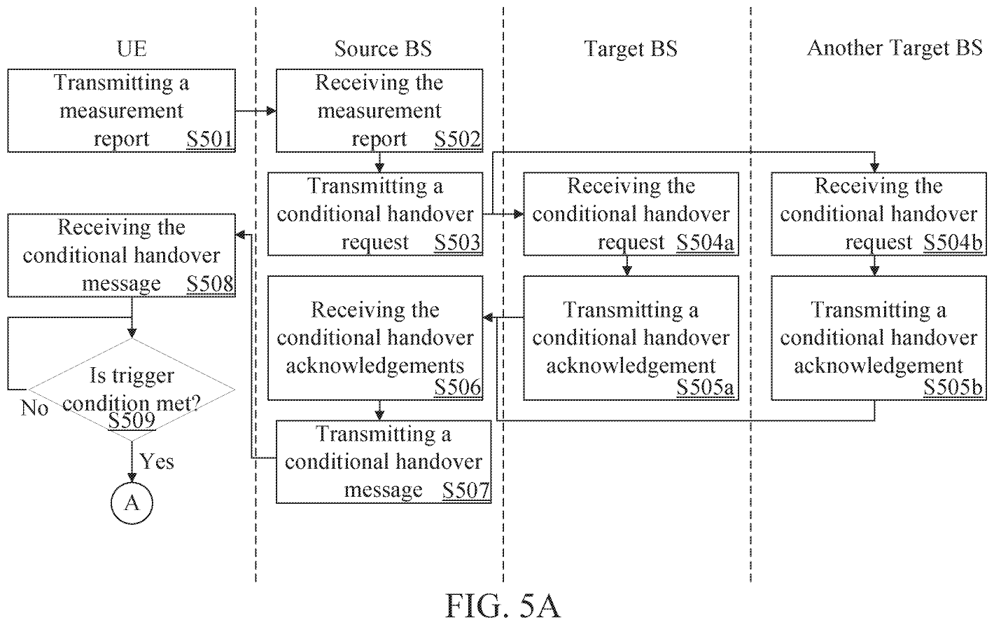

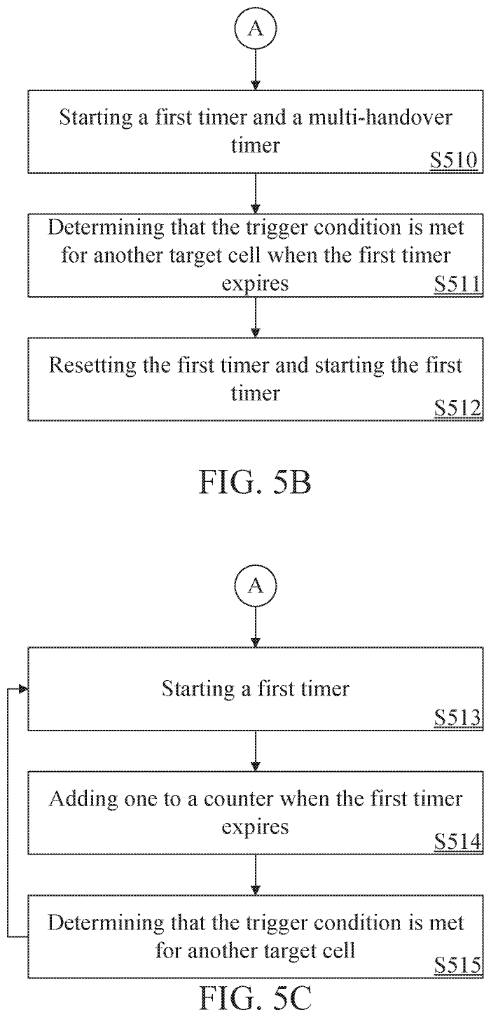

Some embodiments of the present disclosure include a method, and a flowchart diagram thereof is shown in FIGS. 5A through 5C. The method of some embodiments is for use in a network system (e.g., the network system of the aforesaid embodiments), wherein the network system includes a user equipment, a source base station, a target base station with a target cell and another target base station with anther target cell. Detailed operations of the method are described below.

Operation S501 is executed to transmit, by the user equipment, measurement report to the source base station. Operation S502 is executed to receive, by the source base station, the measurement report from the user equipment. Then, the source base station may identify two cells, which are the target cells of the target base stations, respectively, for the user equipment to perform conditional handover to when needed. Operation S503 is executed to transmit, by the source base station (BS), a conditional handover request to both target base stations, for example the Target BS and the Another Target BS, for notifying both base stations of a possible conditional handover.

Operation S504a is executed to receive, by the Target BS, the conditional handover request from the source base station (Source BS). Operation S504b is executed to receive, by another target base station (Another Target BS), the conditional handover request from the source base station (Source BS). Operation S505a is executed to transmit, by the Target BS, a conditional handover acknowledge to the Source BS. Operation S505b is executed to transmit, by Another Target BS, a conditional handover acknowledgement to the Source BS. Operation S506 is executed to receive, by the Source BS, the conditional handover acknowledges from the Target BS and the Another Target BS.

Operation S507 is executed to transmit, by the source base station, a conditional handover message to the user equipment for notifying the user equipment of the target cell of the target base station and the another cell of the another target base station for performing conditional handover when needed. The conditional handover message includes a trigger condition, a first timer, a multi-handover timer and a maximum number of handover. Operation S508 is executed to receive, by the user equipment, the conditional handover message. Operation S509 is executed to determine, by the user equipment, whether the trigger condition has been met.

Please refer to FIG. 5B. In some embodiments, the trigger condition is met for the target cell of the target base station, operation S510 is executed to start, by the user equipment, the first timer for controlling the period of performing conditional handover to the target cell of the target base station and the multi-handover timer for controlling period of performing conditional handover for all available cells.

In some embodiments, when operation S509 is executed to determine that the trigger condition is met, there may be at least five sub-operations performed by the user equipment, for example: (1) determining that the trigger condition corresponding to the target cell of the target base station is met; (2) selecting the target cell of the target base station for performing conditional handover; (3) applying a configuration of the conditional handover message for performing conditional handover to the target cell of the target base station; (4) initiating conditional handover to the target cell of the target base station; and (5) initiating RA to the target cell of the target base station.

In some embodiments, operation S510 is executed with any one of these sub-operations. Accordingly, no matter the first timer is started with which sub-operation, the user equipment terminates the conditional handover to the target cell of the target base station when the first time expires but the conditional handover has not succeeded yet. Then, the user equipment determines whether the trigger condition is met for connection to another cell.

In some embodiments, when the first time expires but the conditional handover has not succeeded yet, the user equipment terminates the conditional handover to the target cell of the target base station. Operation S511 is executed to determine, by the user equipment, that the trigger condition is met for another target cell of the another target base station. Operation S512 is executed to reset and start, by the user equipment, the first timer for controlling the period of performing conditional handover to another target cell of the another target base station. It should be noted that, during the operations, the user equipment stops any possible conditional handover and performs reestablishment with available cell when the multi-handover timer expires.

Please refer to FIG. 5C. In some embodiments, the trigger condition is met for the target cell of the target base station, operation S513 is executed to start, by the user equipment, the first timer for controlling the period of performing conditional handover to the target cell of the target base station.

In some embodiments, when operation S509 is executed to determine that the trigger condition is met, there may be at least five sub-operations performed by the user equipment, for example: (1) determining that the trigger condition corresponding to the target cell of the target base station is met; (2) selecting the target cell of the target base station for performing conditional handover; (3) applying a configuration of the conditional handover message for performing conditional handover to the target cell of the target base station; (4) initiating conditional handover to the target cell of the target base station; and (5) initiating RA to the target cell of the target base station.

In some embodiments, operation S513 is executed with any one of these sub-operations. Accordingly, no matter if the first timer is started with which sub-operation, the user equipment terminates the conditional handover to the target cell of the target base station when the first time expires but the conditional handover has not succeeded yet. Then, the user equipment determines whether the trigger condition is met for another cell.

In some embodiments, when the first time expires but the conditional handover has not succeeded yet, the user equipment terminates the conditional handover to the target cell of the target base station. Operation S514 is executed to add, by the user equipment, one to a counter. Operation S515 is executed to determine, by the user equipment, that the trigger condition is met for the another target cell of the another target base station. Operation S513 is executed to restart, by the user equipment, the first timer for controlling the period of performing conditional handover to another target cell of the another target base station. It should be noted that, during the operations, the user equipment stops any possible conditional handover and performs reestablishment with available cell when the counter reaches the maximum number of handover.

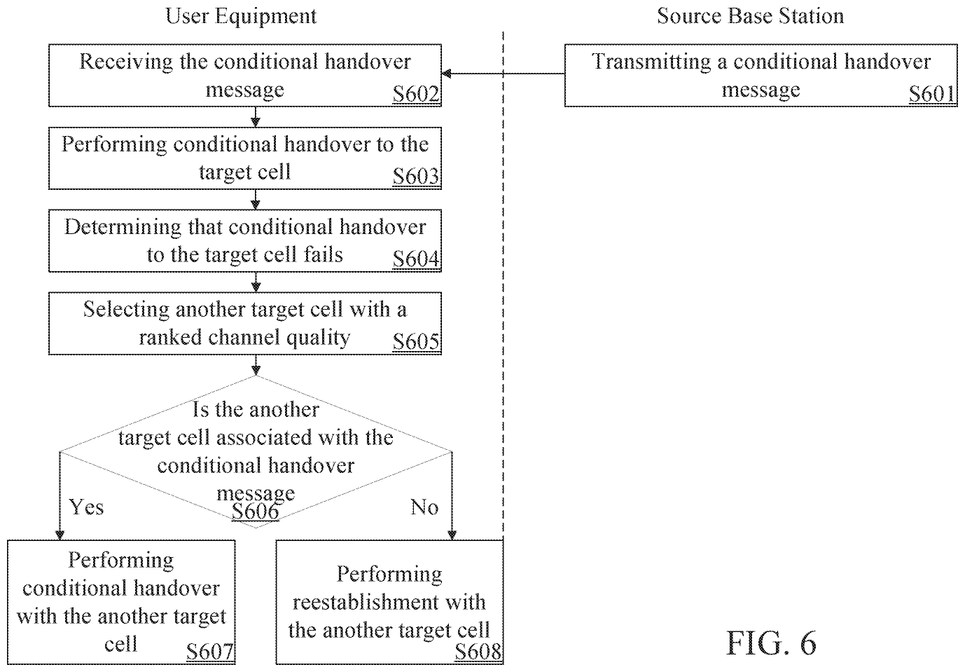

Some embodiments of the present disclosure include a method, and a flowchart diagram thereof is shown in FIG. 6. The method of some embodiments is for use in a network system (e.g., the network system of the aforesaid embodiments), wherein the network system includes a user equipment, a source base station, a target base station with a target cell and another target base station with anther target cell. Detailed operations of the method are described below.

Operation S601 is executed to transmit, by the source base station, a conditional handover message to the user equipment. Operation S602 is executed to receive, by the user equipment, the conditional handover message from the source base station. The conditional handover message includes a trigger condition. When the trigger condition is met, operation S603 is executed to perform, by the user equipment, conditional handover to the target cell of the target base station.

In some embodiments, operation S604 is executed to determine, by the user equipment, that conditional handover to the target cell fails. Operation S605 is executed to select, by the user equipment, another target cell with a channel quality. Operation S606 is executed to determine, by the user equipment, whether to perform conditional handover to another target cell when the another target cell is associated with the conditional handover message or to perform reestablishment with the another target cell when the another target cell is not associated with the conditional handover message.

When another target cell is associated with the conditional handover message, operation S607 is executed to perform, by the user equipment, conditional handover to another target cell of the another target base station. When another target cell is not associated with the conditional handover message, operation S608 is executed to perform, by the user equipment, reestablishment to another target cell of the another target base station.

In some embodiments, another target cell may be selected because the channel quality of another target cell is the highest channel quality value among the channel quality values of the available target cells. In other words, the priority of selecting the cell depends on the channel quality value. Accordingly, the cell with higher channel quality value has higher priority of being selected.

In some embodiments, for raising the priority of being selected of another target cell, the conditional handover message may include an offset designated to increase a channel quality value corresponding to another target cell. In detail, the user equipment may update the channel quality value (which corresponds to another target cell) by applying the offset. In other words, the channel quality value (which corresponds to another target cell) may be added to the offset (i.e., the channel quality value may include the offset). Accordingly, the priority of being selected of another target cell may be raised.

In some embodiments, when another target cell of the base station is associated with the conditional handover message, the user equipment further determines whether the channel quality value (which corresponds to the another target cell) meets a threshold. When the user equipment further determines that the channel quality value (which corresponds to another target cell) meets the threshold, the user equipment performs conditional handover to the another target cell of the another target base station. In some embodiments, the threshold may include a cell selection criterion as mentioned in the aforesaid embodiment.

It should be noted that the user equipment, which has received a conditional handover message from the source base station, may receive a conventional handover message from the source base station. In some embodiments, the user equipment releases the resources of the conditional handover message when receiving the conventional handover message.

In some embodiments, the user equipment does not release the resources of the conditional handover message when receiving the conventional handover message. And the first timer and multi-handover timer mentioned in the aforesaid embodiments may be introduced after conventional handover failure.

The method of the present disclosure can be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that hasa finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this document, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A method comprising:
receiving, by a user equipment, a conditional handover message from a source base station, wherein the conditional handover message includes a trigger condition and a first timer corresponding to a target cell;
determining, by the user equipment, that the trigger condition is met; and
starting, by the user equipment, the first timer corresponding to the target cell.

2. The method of claim 1, wherein the first timer is started based on determining that the trigger condition is met.

3. The method of claim 1, further comprising:
selecting, by the user equipment, the target cell for performing conditional handover;
wherein the first timer is started based on selecting the target cell for performing conditional handover.

4. The method of claim 1, further comprising:
applying, by the user equipment, a configuration of the conditional handover message for performing conditional handover to the target cell;
wherein the first timer is started based on applying the configuration for performing conditional handover to the target cell.

5. The method of claim 1, further comprising:
initiating, by the user equipment, conditional handover to the target cell;
wherein the first timer is started based on initiating conditional handover to the target cell.

6. The method of claim 1, further comprising:
initiating, by the user equipment, random access to a target base station;
wherein the first timer is started based on initiating random access to the target base station.

7. The method of claim 1, wherein the conditional handover message further comprises a second timer corresponding to another target cell, and the method further comprises:
determining, by the user equipment, that the trigger condition corresponding to the another target cell is met when the first time expires;
starting, by the user equipment, the second timer corresponding to the another target cell.

8. The method of claim 1, wherein the conditional handover message further comprises a multiple-handover timer and the multiple-handover timer is started with the first timer.

9. The method of claim 8, further comprising:
performing, by the user equipment, reestablishment when the multiple-handover timer expires.

10. The method of claim 1, wherein the conditional handover message further comprises a maximum number of handover, and the method further comprises:
performing, by the user equipment, reestablishment when a counter is equal to or greater than the maximum number of handover.

11. A method comprising:
determining, by a user equipment, that conditional handover to a target cell fails;
selecting, by the user equipment, another target cell with a channel quality;
determining, by the user equipment, whether to perform conditional handover to the another target cell when the another target cell is associated with a conditional handover message or to perform reestablishment with the another target cell when the another target cell is not associated with the conditional handover message.

12. The method of claim 11, wherein an offset is added in the channel quality related with the conditional handover message.

13. The method of claim 11, wherein determining to perform conditional handover further comprises:
determining, by the user equipment, to perform conditional handover to the target cell when the target cell is associated with the conditional handover message and the channel quality associated with the target cell meets a threshold.

29. A user equipment comprising:
a processor for:
determining that conditional handover to a target cell fails;
selecting another target cell with a channel quality;
determining whether to perform conditional handover to the another target cell when the another target cell is associated with a conditional handover message or to perform reestablishment with the another target cell when the another target cell is not associated with the conditional handover message.

30. The user equipment of claim 29, wherein an offset is added in the channel quality related with the conditional handover message.

31. The user equipment of claim 29, wherein the processor further determines to perform conditional handover to the another target cell when the another target cell is associated with the conditional handover message and a channel quality associated with the target cell meets a threshold.
